(19) United States
(12) Patent Application Publication
(10) Pub. No.: US 2008/0313068 A1
(43) Pub. Date: Dec. 18, 2008

(54) SYSTEMS AND METHODS FOR ENABLING BORROWING OF STOCK

(75) Inventor: Yi Sun, Honolulu, HI (US)

Correspondence Address: Weiss & Arons, LLP, 1540 Route 202, Suite 8, Pomona, NY, 10970, US

(73) Assignee: TORA TRADING SERVICES LTD., San Francisco, CA (US)

(21) Appl. No.: 11/763,682

(22) Filed: Jun. 15, 2007

(51) Int. Cl. G06Q 40/00

(52) U.S. Cl. 705/37; 705/35

(57) ABSTRACT

Systems and method for enabling borrowing of stock according to the invention have been provided. One method of facilitating borrowing shares of a pre-determined stock according to the invention may include receiving a list of guaranteed stock lenders. The system may display the list of guaranteed stock lenders in a Graphical User Interface. In response to a selection of one of the guaranteed stock lenders, the system may display an interactive stock borrow dialogue box. The interactive stock borrow dialogue box may display an input field that is adapted to receive an amount of shares that a borrower desires to borrow and that displays a lender field. Following the user selection of a lender, the lender field may be pre-populated—i.e., populated upon initial display of the interactive stock borrow dialogue box—with the user-selected lender. Preferably, the user may modify the lender field.

### BACKGROUND OF THE INVENTION

This invention relates to electronic trading systems. Specifically, this invention relates to using electronic trading systems and methods for facilitating borrowing of common stock. Even more specifically, this invention relates to facilitating borrowing of stock in order to cover short positions held in the stock.

Typically, traders or other market participants may sell stock without actually holding a position in the stock. However, in order to consummate the sale of the stock, the market participants must actually deliver the stock before the end of a pre-determined period. This requirement forces the market participant to either go into the market and purchase the amount of shares of stock that the participant has sold in order to deliver the shares of stock to a purchaser before the end of the pre-determined period—e.g., a trading day—during which the sale occurred, or, alternatively, to borrow shares from a third party and use the borrowed shares to meet the delivery requirements—i.e., cover the market participant's short sales.

While purchasing the shares of the stock needed to meet the delivery requirements is straightforward, it may run contrary to a particular investor's investment strategy—i.e., purchasing the shares severely restricts the ability of the investor to sell a stock short because it limits the duration of the short sale to a single day, or to some other shortened pre-determined time period.

The second conventional method of “covering” short sales is to borrow the necessary shares of stock in order to deliver the stock to the purchaser. However, this method may be expensive because the current market for stock borrowing is non-transparent and contains inefficiencies. As such, stock lenders typically charge high premiums for stock loans. These premiums reduce the borrowers' profits associated with short selling.

Accordingly, it would be desirable to introduce an electronic market for stock lending in order to increase transparency and reduce inefficiencies related to selling stock short.

It would also be desirable to display borrow rates associated with multiple stock lenders in order to allow borrowers to select a lender based on lowest price and available quantity and to increase transparency and liquidity of the stock borrow market as well as numerous other reasons.

It would also be desirable to make stock borrowing terms electronically available because such electronic availability promotes short selling via a client-based Application Programming Interfaces (APIs).

### SUMMARY OF THE INVENTION

It is an object of the invention to display borrow rates associated with multiple stock lenders in order to allow borrowers to select a lender based on lowest price and available quantity.

It is another object of the invention to make stock borrowing terms electronically available because such electronic availability promotes short selling via client-based Application Programming Interfaces (APIs).

In one embodiment of the invention, a graphical user interface (GUI) that facilitates borrowing shares of a pre-determined stock is provided. The GUI according to the invention may display a plurality of lender names, a number of shares of the pre-determined stock available from each lender, and a lending rate associated with each of the lender names.

The aforementioned embodiment of the invention constructs a lender list with respect to one or many stocks. Some of these lenders may guarantee to certain selected borrowers the availability of certain stocks. The list allows the user to “just click” to select a lender and then to request an amount of stock to borrow. Following execution of the stock loan, notification may then be sent from the borrowing system to the lender and to the borrower that a stock loan has been executed.

In certain stocks, lenders do not typically guarantee that a loan of the stock is available. With respect to these stocks, a system according to the invention may generate a request-for-quote (RFQ) to a number of lenders. The RFQ may include an embedded web-link to the stock borrow system according to the invention. The lenders may then click on the link and reply to the stock borrow system by specifying a quantity of available stock for loan as well as lending rates associated therewith. Thereafter, the stock borrow system may aggregate and/or forward the information to the client/borrower. The borrower can then select a subset of quantity as well as select the lender from whom the borrower wishes to borrow. Following the execution of the borrow, the stock borrow system may generate a report of the executed stock borrow and transmit the report to at least one of, and preferably all of, the lending desk(s) that provided the loan, the prime broker that is the custodian for the borrower's accounts, and the client/borrower.

In further alternative embodiments, the various lenders can select which rates and which availability can be shown to which clients/borrowers. Thus, a stock borrow system according to the invention preferably provides a mechanism for preferential treatment between and among the clients/borrowers as desired by the lenders. Such treatment may be implemented through a GUI or other suitable means for allowing the lender to identify/select and specify the quantities and rates of stock available for loan to each selected borrower.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a block diagram of a system that may be used to implement the processes and functions of certain embodiments of the present invention;

FIG. 2 is a block diagram of a workstation and a server that may be used to implement the processes and functions of certain embodiments of the present invention;

FIG. 3 shows an aggregated and segregated indication of interest graphical user interface (GUI) according to the invention;

FIG. 4 shows an interactive order dialogue box according to the invention;

FIGS. 5A and 5B show a stock borrow lender list and an interactive stock borrow information box, respectively, according to the invention;

FIG. 5C shows an interactive stock return dialogue box according to the invention;

FIG. 5D shows an exemplary excess borrow report that can be used in methods according to the invention;

FIG. 6 shows a first stock borrow blotter according to the invention; and

FIG. 7 shows an interactive stock borrow dialogue box according to the invention.

### DETAILED DESCRIPTION OF THE INVENTION

In one embodiment, the invention provides a graphical user interface (GUI) that facilitates borrowing shares of a pre-determined stock. The GUI may display a plurality of lender names. The GUI may also display a number of shares of the pre-determined stock available from each lender and a lending rate associated with each of the lenders.

In some embodiments, the GUI may form part of a more comprehensive electronic trading system. In such, or other, embodiments, the GUI may also display an update field that displays updates in response to activity internal to the electronic trading system. Activity internal to the trading system may be defined as a stock borrowing event that one of the users completed using the electronic trading system.

In one embodiment of the invention, an electronic trading system may display an interactive stock borrow dialogue box in response to a user selection of one of the plurality of lender names. The interactive stock borrow dialogue box may also include an indication of interest field. An “indication of interest” is defined for the purposes of this application as a dealer's or investor's interest in purchasing (or selling) securities that are typically, but may not be, registered with the Securities and Exchange commission or with some other national regulatory body (such as a regulating body in a foreign country). The indication of interest field may be displayed together with an aggregated and segregated one indication of interest or a plurality of indications of interest in the stock which, when not displayed with the party associated with the indication of interest, may be obtained by user selection of a selectable field or button associated with the indication of interests. The indications of interests may be segregated by buy and sell indications—i.e., all buy indications may be on one side of the indications of interests display (independent of a quantity associated with the particular indication of buy) and all sell indications may be on the other side (or another suitable differentiated position) of the indications of interest display. The buy indications may be separated from the sell indications by a line or other suitable visual indicator. The indication of interest field may also display a visual indication of a historical trend of indications of interest in the stock.

In certain embodiments, the GUI may display an update field that displays updates in response to activity internal to and/or external from the electronic trading system. In these, or other embodiments, the GUI may display a dividend rate field that displays allocation rates of future dividends with respect to the lender and a borrower. In addition, the GUI may display a call/non-callable field. The call/non-callable field may display the callability of the shares of stock. The callability of the shares of stock relates to the lender's ability to require the borrower to return the shares in response to the lender's request, independent of whether the term of the loan has expired. Another field that the GUI may display is a delivery field. The delivery field displays a party to whom the shares of stock are transferred from the lender. Such a party may be the “prime broker” for the borrower. The prime broker is typically in charge of settling the borrower's accounts at the end of a trading day and, therefore, requires delivery of the stock provided by the lender. The GUI may also include a comment field. The comment field provides a platform for interactive communication between a borrower and the lender.

The GUI may also include a current borrow position field that displays a participant's current borrow position in the stock. Similarly, the GUI may display a pending borrow position field that displays a participant's submitted but currently unexecuted borrow position.

Additionally, the GUI may display an over/under borrow field. The over/under borrow field may show an indication of the amount of shares of stock the borrower must deliver by the end of the time period set forth in his short sale contract(s) less the amount currently borrowed or that the borrower otherwise possesses (or has rights to). An underborrowed position may be indicated by showing a negative sign adjacent to the value specified in the over/under borrow field.

In a similar vein to the embodiments of the invention that relate to the concept of over or under borrowing, the invention may include embodiments that display information to the user that relates to the cost of the borrowing for a particular order. Thus, in a situation where a user had over-borrowed—e.g., had borrowed 50,000 shares of a particular stock but only sold short 12,000 shares—such an embodiment would show that the borrowing cost was relatively high for the amount sold short. Furthermore, a single fund which included multiple traders could easily and efficiently compile the total borrowing costs associated with a single stock and, by doing so, increase efficiencies of borrowing by eliminating over-borrowing.

A method according to the invention of facilitating borrowing shares of a pre-determined stock may include the following steps. First, the method may include receiving a list of stock lenders (which may or may not guarantee availability of a certain number of shares to selected lenders or, alternatively, to all lenders). Each of the lenders may guarantee the availability of a pre-determined number of shares of the stock. Then, the method may include storing the list of guaranteed stock lenders and the pre-determined number of shares of the stock guaranteed by each of the lenders. The method may also include displaying the list of guaranteed stock lenders in a Graphical User Interface. A user may be able to select one or more of the lenders from the list. In response to a selection of one of the guaranteed stock lenders, the method may also include displaying an interactive stock borrow dialogue box. The interactive stock borrow dialogue box may display an input field that is adapted to receive an amount of shares that a borrower desires to borrow.

When the list of guaranteed stock providers includes less providers than a predetermined threshold number, the method may include transmitting a request for quote instruction to lenders in order to determine whether the lenders agree to guarantee the availability, and borrowing rates, of a pre-determined number of shares of the stock.

In an alternative embodiment, when a stock is not guaranteed by one (or some pre-determined number) of the guaranteed stock lenders, the method may include providing an interactive electronic platform for negotiation between the lender and a borrower in order to determine the terms of borrowing the stock.

In certain embodiments, the method may include updating the amount of stock available from at least one of the guaranteed stock lenders in response to information relating to the lending of the stock by the at least one of the guaranteed stock lenders. This updating may, in the alternative, occur daily or upon an exceptional corporate event related to the company—e.g., a default event, a bankruptcy or other extraordinary event. In certain embodiments of the invention, the method may include maintaining the validity of the amount of stock available from at least one of the guaranteed stock lenders until an update is received from the guaranteed stock lender.

The updating may be implemented in one of a number of ways. The method may include receiving an electronic file from a lender and updating the amount of stock available from a lender in response to the receipt of the electronic file. The file preferably includes the availability and lending rate of a pre-determined number of shares of the stock.

Alternatively, the method may include receiving files from an application programming interface associated with a guaranteed stock lender or obtaining files from a password protected internet, intranet, extranet, or other suitable site. Such a site may also typically be associated with a guaranteed stock lender.

Another graphical user interface (GUI) that facilitates borrowing shares of a pre-determined stock according to the invention may also include a plurality of borrower list tabs. Each of the plurality of borrower list tabs provides user access to another GUI or related site. One of the additional GUIs may facilitate borrowing of shares of a restricted stock. Such restrictions may be related to, or include, shares of stock that are restricted because of ownership issues—e.g., a particular borrowing participant may be restricted because he/she owns too many of the shares of a certain stock—or the shares may be restricted because of some other regulation or circumstance.

In one additional embodiment of the invention possible for use with client-side APIs, an electronic trading system may provide electronic borrowing capability according to a predetermined set of rules received from a client. Thus, a client, or a client API, can specify that when (or before) it “shorts” —i.e., agrees to sell without actually owning—a particular stock, the electronic trading system may determine whether the amount of stock that is shorted, or some other suitable amount, is available to be borrowed. Thereafter, the rules set forth by the client may require that the electronic trading system obtain the stock according to a rule-based hierarchy. For example, the client may first require that the stock be borrowed from the lender that provides the desired volume at the lowest borrowing rate. If multiple lenders can provide the desired volume at the lowest rate, then the rules may require that the lender also offer the stock as a non-callable loan. If multiple lenders are still able to meet the specified terms, then the borrower may have a preference list for choosing between lenders in such cases, or some other criteria may be introduced that further limits the list. It should be noted that the foregoing represents only one particular set of rules and/or parameters pursuant to which a participant may elect to borrow stock. Nevertheless, a participant may elect to propose a different, participant-defined hierarchy, according to which the user may borrow stock from a single or multiple providers. In yet another embodiment, the electronic trading system may provide a system-defined hierarchy that allocates the order to borrow stock to either a single lender or a group of lenders.

Additionally, each country in which the stock borrow takes place may dictate certain aspects of the rule-based hierarchy. For example, the callability of a stock may not affect the lender hierarchy in Japan because, typically, all stock borrows are non-callable, but callability may affect the hierarchy of lenders in Korea. As such, the rule-based hierarchy may include country-dependent parameters.

It would be apparent that a GUI according to the invention may also show only a sub-set of all the information available to a system in which the GUI is stored. For example, the subset of information may list guaranteed lender names offering to lend a particular stock and/or other suitable financial instrument and, upon a click or other suitable selection, show further information relating to the borrowing terms available from a particular lender. Such further information may particularly include the shares available and or other terms related to lending the shares, such as price of borrowing (interest). Thus, it is within the scope of the invention to provide a GUI or method that preferably shows only a smaller subset of the available amount of information, but that displays additional information upon user selection or some other suitable impetus.

In a yet further embodiment of the invention, the GUI may also include an optional selectable input field that is adapted to receive an instruction from the borrower to repay the borrowed stock. Thus, if the borrower bought the stock back, after having sold the stock short, the borrower could then select on option that the borrowed stock should be returned and the loan, and associated fees, should terminate from that point in time forward.

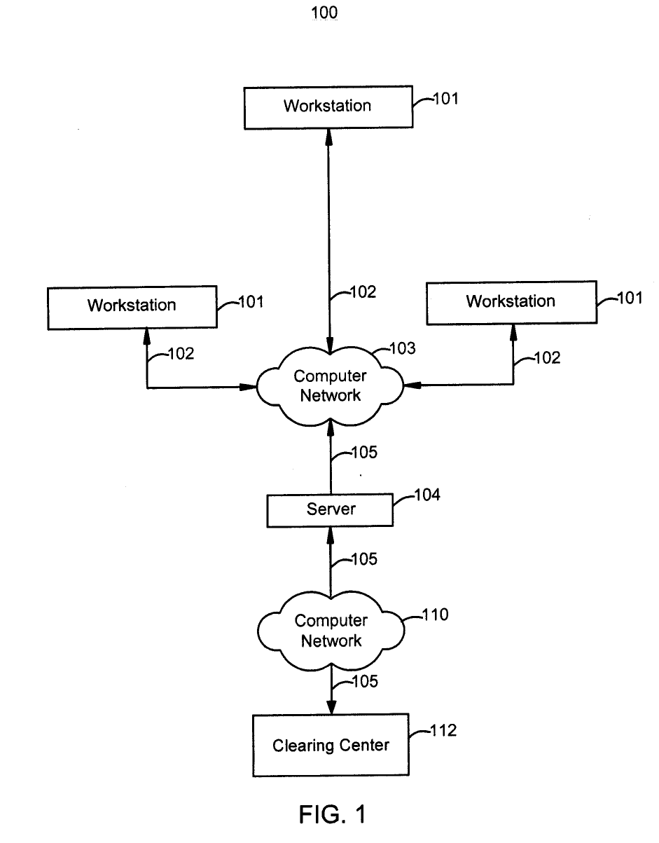

Referring to FIG. 1, exemplary system 100 for implementing the present invention is shown. As illustrated, system 100 may include one or more workstations 101. Workstations 101 may be local or remote, and are connected by one or more communications links 102 to computer network 103 that is linked via communications links 105 to server 104. Server 104 is linked via a communications link 105 through computer network 110 and, preferably, an additional communications link 105 to back office clearing center 112. It should be noted that computer network 110 may be adapted to communicate with stock loan providers using interconnections such as a network that uses FTP, e-mail, access via web/XML, a FIX connection or any other suitable communications link.

In system 100, server 104 may be any suitable server(s), processor(s), computer(s), or data processing device(s), or combination(s) of the same. Server 104 may be used to process and settle the transactions entered into by one or more participants.

Computer network 103 and/or 110 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 102 may be any communications links suitable for communicating between workstations 101 and server 104, such as network links, dial-up links, wireless links, hard-wired links, etc. Back office clearing center 112 may be any suitable equipment, such as a computer, a laptop computer, a mainframe computer, etc., or any combination of the same, for causing transactions to be cleared and/or verifying that transactions are cleared. Communications link 105 may be any communications links suitable for communicating data between server 104 and back office clearing center 112, such as network links, dial-up links, wireless links, hard-wired links, etc.

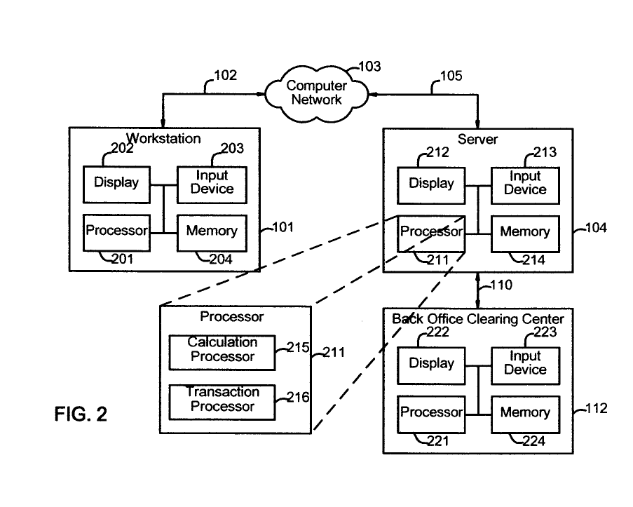

The server, the back office clearing center, and one of the workstations, which are depicted in FIG. 1, are illustrated in more detail in FIG. 2. Referring to FIG. 2, workstation 101 may include processor 201, display 202, input device 203, and memory 204, which may be interconnected. In a preferred embodiment, memory 204 contains a storage device for storing a workstation program for controlling processor 201. Processor 201 uses the workstation program to present on display 202 information relating to trading functions to a user of workstation 101. Such transaction information may include transaction information relating to stock borrow. Furthermore, input device 203 may be used to receive acceptance of such offers and to enter into transactions and other communications involving such borrowing.

Server 104 may include processor 211, display 212, input device 213, and memory 214, which may be interconnected. In a preferred embodiment, memory 214 contains a storage device for storing transaction information relating to the transactions entered into by the borrower and the lender. The storage device further contains a server program for controlling processor 211. Processor 211 uses the server program to transact the loan of the shares of stock. Processor 211 may include calculation processor 215 that calculates the fees that are charged as a result of the borrowed stock. Processor 211 may also include transaction processor 216 that may process transactions.

Back office clearing center 112 may include processor 221, display 222, input device 223, and memory 224, which may be interconnected. In a preferred embodiment, memory 224 contains a storage device for storing a clearing program for controlling processor 221. Processor 221 uses the clearing program to complete the transactions that are entered into by the lender and the borrower and to clear these transactions as well. Processor 221 uses the clearing program to further verify that the transactions are completed and cleared.

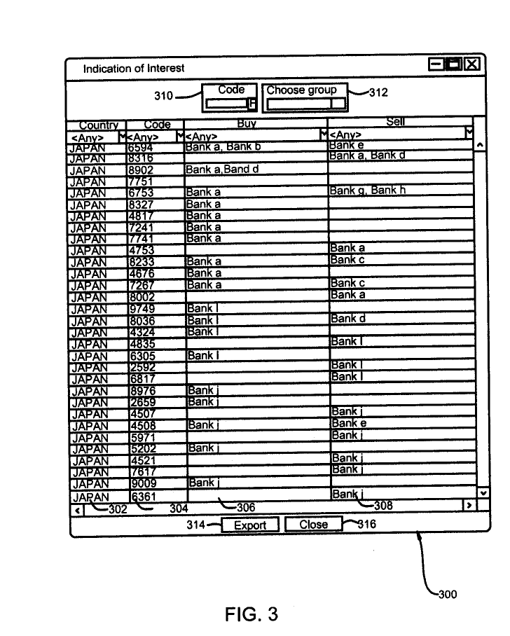

FIG. 3 shows an aggregated and segregated indication of interest Graphical User Interface (GUI) 300 according to the invention. Indication of interest GUI 300 includes a country field 302, which indicates the country in which the stock is traded and/or based, a code field 304, which indicates the stock to which the indication of interest is directed, abuy indication field 306 and a sell indication field 308. Field 310 is adapted to receive an input relating to the particular stock in which the user is interested. Field 312 is adapted to receive the specification of the group with which the user is affiliated. Finally, export button 314 is adapted to receive a user selection to export a portion or all of the information from GUI 300 to an external location. Finally, close button 316 is adapted to receive a user selection to close GUI 300.

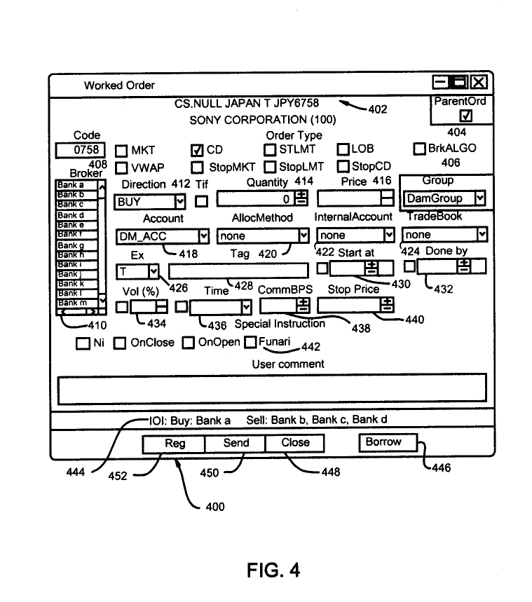

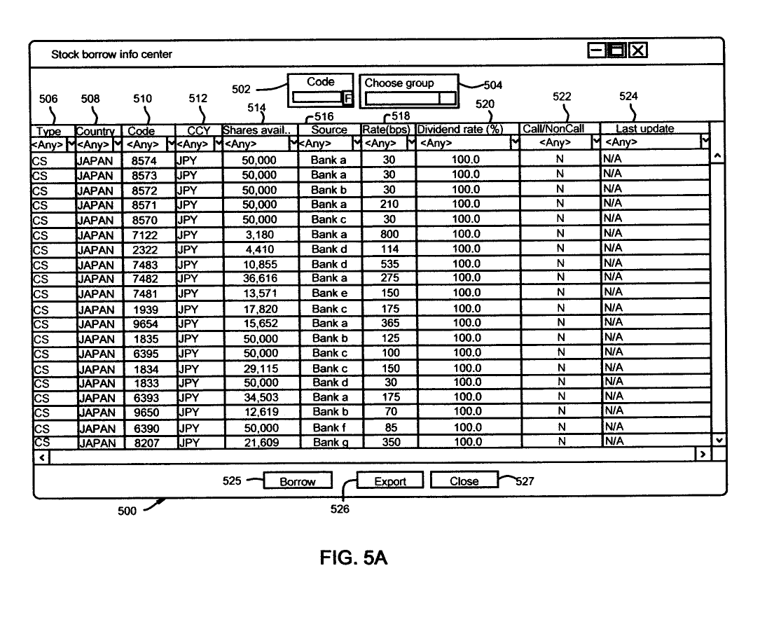

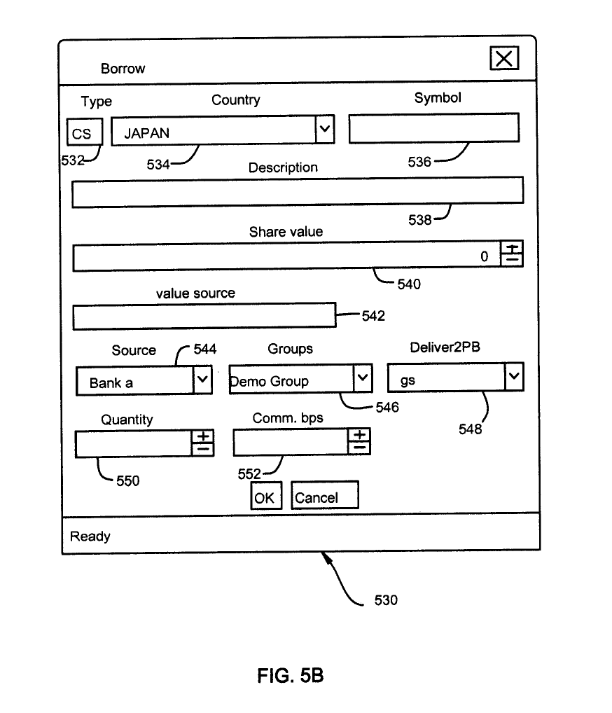

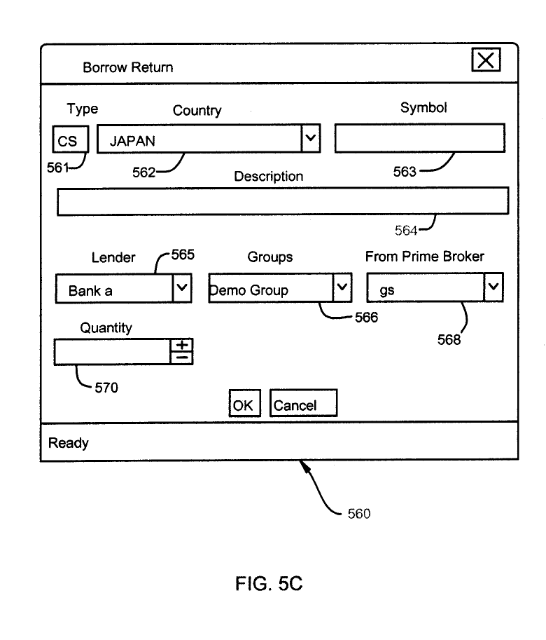

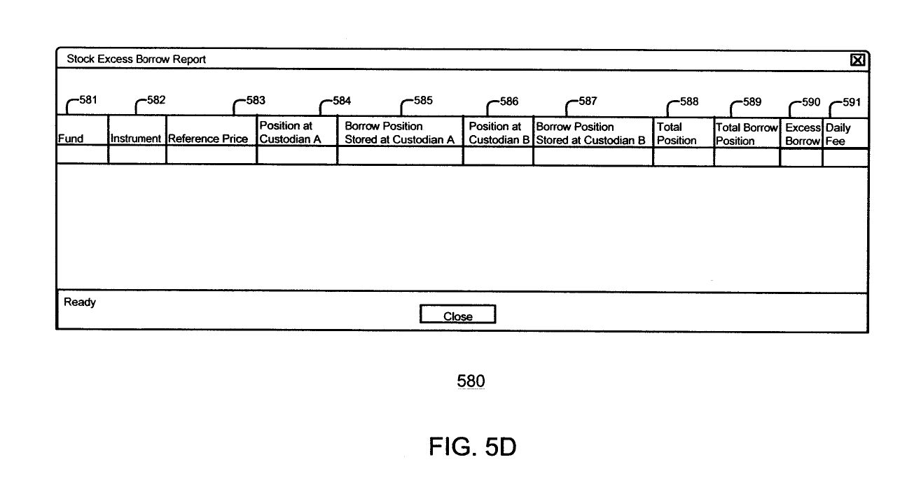

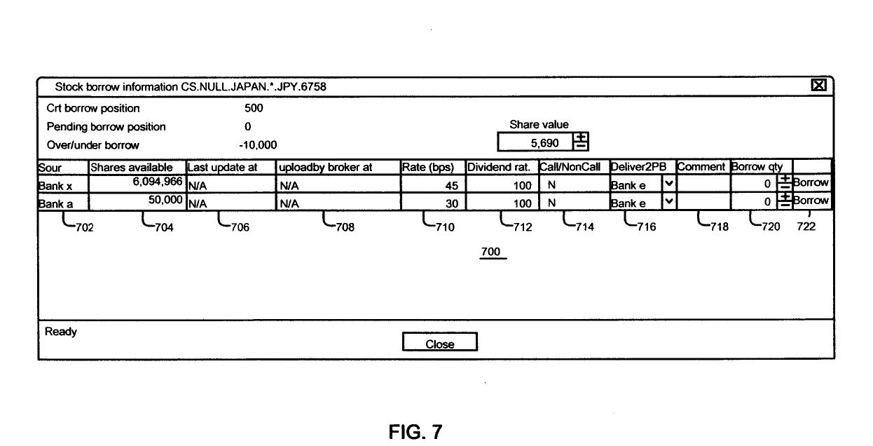

FIG. 4 shows an interactive order dialogue box 400 Graphical User Interface (GUI) according to the invention. GUI 400 preferably includes order specification field 402 which specifies the stock, country and other identifiers relating to the order about to be placed; parent order field 404 which specifies whether the order is a parent order—i.e., an order that is not yet broken down and routed to multiple brokers, each of which multiple brokers may execute a predetermined proportion of the parent order, but, rather, represents a single order that may or may not be broken down and allocated to multiple brokers; order type field 406 which is adapted to receive a user instruction to specify the type of order including but not limited to a MKT (market order), a VWAP (volume weighted average price) order, a CD (Careful Discretion) order, a StopMKT (a stop market order), a STLMT (Straight Limit Order), a StopLMT (a stop limit order), an LOB (Limit Or Better order), a StopCD (stop price associated with Careful Discretion), and a BrkALGO (opens ALGORITHMIC trading entry screen and provides access to a broker algorithmic trading system); a stock code field 408 which is adapted to receive a user specification of the code of the stock that the user is interested in trading; a broker field 410 that is adapted to receive a user instruction relating to which broker the user wishes to use for the order; direction field 412 which receives a user specification as to which direction—e.g., buy or sell—the user desires to trade the stock; quantity field 414 which is adapted to receive a specification of the amount of stock the user wishes to trade; price field 416 which receives a user specification of a price (which may or may not depend at least in part on the order type); account field 418 which is adapted to receive a specification of the client relating to the identification of the prime broker, physical account, etc., and that is to be transmitted to the broker; allocation field 420 which is adapted to receive a specification of the method according to which the client wishes to dynamically change allocation of the order among the client's internal accounts and/or tradebooks; internal account field 422 which is adapted to map some specified subset of a client's trading flow; TradeBook field 424 which is adapted to map some specified subset of a client's trading flow (same function as internal account field); Ex field 426 which shows on which exchange the order was executed; tag field 428 which is the same as the aforementioned trade book or internal account fields; start-at field 430 which shows the time at which the trade is scheduled to begin; done-by field 432 which shows the time at which the order should be completed; vol (%) field 434 which shows what percentage of the market volume of the instrument that the user's order cannot exceed; Time field 436 which specifies the time at which the trade should occur; Comm.BPS field 438 which displays the commission in Basis Points ( 1/100^{th} of 1%) for the order; Stop Price field 440 which is associated with any of the stop orders listed above; special instructions field 442 which is adapted for the user to input special instructions (which may be customizable) regarding the order such as to execute the order at market open, at market close, Funari (a limit order that becomes a market order at the close) and NI (no impact); indications of interest compilation field 444 which displays a visual indication of the number and type—e.g., side (either buy or sell)—of indications of interests that have been circulated for the stock specified in the coded area such as field 402(or for some other specified stock); borrow button 446 which may, in certain embodiments of the invention, cause to appear an interactive stock borrow dialogue box (see FIGS. 5A, 5B, and 7) to determine the availability to borrow a certain stock, and, if available, to borrow the stock; close button 448 which closes the dialogue box; send button 450 which may send the specified order to an electronic trading system, an ECN (electronic crossing network) or other appropriate system; and Register button 452 (which “desks” an order, which means a selection by the trader, or a third party such as a clerk, to enter an order, but not execute the order, and have the order ready at some later time).

FIGS. 5A and 5B show a stock borrow guaranteed lender list 500 and an interactive stock borrow information box 530, which may be used for execution of a manual borrow event, respectively, according to the invention.

Stock borrow guaranteed lender list 500, as shown in FIG. 5A, may preferably include code field 502 (in FIGS. 5A, 5B, and 7, where fields are not described in more detail, the descriptions of the fields should be understood to be as previously described above); group field 504; type field 506 (such as CS—common stock); country field 508; code field 510; currency (CCY) field 512; quantity of shares available to borrow from the lender 514; lending source field 516; borrow rate in basis points 518; dividend rate field 520 which displays allocation rates of future dividends with respect to the lender and a borrower; call/non-call field 522; and time of last update field 524.

FIG. 5B shows interactive stock borrow information box 530. Information box 530 shows type field 532; a country field 534; a (stock) symbol field 536; a further description field 538; a share value field 540; a value source field 542—i.e., from whence the value for the stock as shown in value field 540 was derived; lending source 544; internal group field 546; Deliver2PB (prime broker) field 548; quantity field 550; and Comm.BPS field 552.

FIG. 5C shows a return of borrowed stock interactive dialogue box 570 according to the invention. Box 570 preferably includes type field 561, country field 562, symbol field 563, description field 564, lender (to be returned to) field 565, groups field 566, from Prime Broker field 568 and quantity returned field 570.

FIG. 5D shows an excess borrow report 580 that can be used in methods according to the invention. The importance of such a report, according to the invention, is as follows. For any excess borrow, the borrower is paying a daily extra fee and receiving no value in return. The ability to manage and cut down excess borrow directly improves the borrower's bottom line trading cost.

Excess borrow report 580 preferably includes the following fields: a fund identification field 581 (that identifies the borrower entity), an instrument identification field 582, a reference price field 583 that identifies the current price of the instrument, a position at prime broker A field 584 that identifies the borrower's position with respect to the amount already sold short, a borrow position stored at prime broker A field 585 that identifies the borrow position at prime broker A, a position at prime broker B field 586, and a borrow position stored at prime broker B field 587, a total position field 588, a total borrow position field 589, an excess borrow field 590 and a daily borrow fee field 591.

The following is one exemplary embodiment in which report 580 may be helpful to a trader.

If a user has position in Sony stock of −500 at prime broker A—i.e., the user has sold short 500 shares of Sony stock, and borrowed position of 600 from bank B. Further, if the client has another prime broker B, and has 0 position at prime broker c, and a borrowed position of 400, borrowed from bank D, then the user's total position is 500 short, and total borrowed pos of 1000 from banks B and D. This example indicates that the client borrowed 1000 from banks B and D, and designated 600 to prime broker A and 400 to prime broker C. However, so far, the user only short sold 500 shares. Thus, the user currently has an excess borrow of 500, for which he is paying a daily fee. If he has no intention to short sell further, then he should return the 500 borrow back to some combination of banks B and D. While most users typically have only one prime broker, the above example generalizes the over borrow situation.

The cost of borrow (or daily fee) may be determined according to the following algorithm or some other suitable algorithm:

Ref stock price (normally close/settle price)*borrow qty*(rate, like 45 bps (basis points), which is equivalent to 0.0045)/360.

It should be noted that if the client intends to short sell Sony another −2000 in the near future, he would currently only need to borrow another 1500 to meet the short sell requirement.

Such excess borrow position may be linked to other GUIs, as is shown on top of FIG. 7.

Preferably, report 580 allows a user to identify whether excess borrow exists and, if excess borrow exists, at what cost. More detailed columns can be added which identify the daily cost of the excess borrow. In certain embodiments of the invention, a report (not shown) similar to the report shown in FIG. 5D can include a link to an interactive return excess borrow dialogue box similar to box 570, but adapted—e.g., pre-populated—with information such as amount of to be returned. In one additional embodiment of such a graphical user interface, the interactive dialogue box could also be pre-populated with the lender who is owed the stock.

In yet another alternative embodiment of the invention, a plurality of reports 580 can be viewed by a user such that the user can identify which instrument, among the instruments the user is currently involved with, has an excess borrow. In an alternative embodiment of this embodiment, an additional row could be added to stock borrow dialogue box 700 (see below in FIG. 7) to display the current position in the instrument as well as the current borrow position (and excess borrow position).

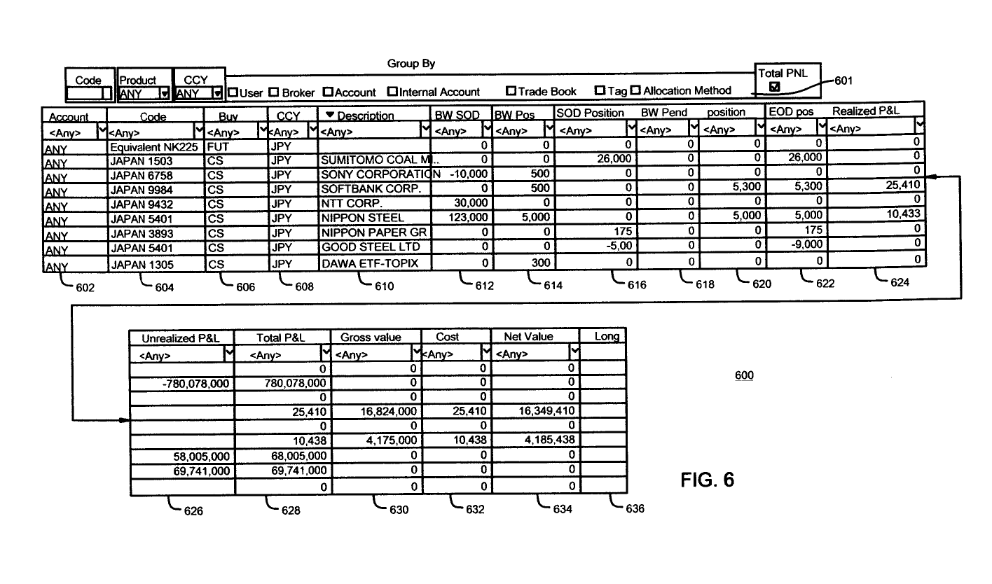

FIG. 6 shows a total position (including borrowed position) blotter according to the invention. Stock borrow blotter 600 preferably includes account field 602; stock code field 604; instrument purchase field 606; currency (ccy) field 608; instrument description field 610; borrow start of day position field 612; (current) borrow position field 614; start of day stock position field 616; borrow pending field 618, which specifies if the borrower has sent a borrow order to a lender but the borrow order is still pending and not yet executed; position field 620; end of day position field 622; realized and confirmed profit and loss field 624; unrealized profit and loss field 626—i.e., the profit or loss that would be realized if the user were to liquidate his present position; total profit and loss field 628; gross value field 630; cost (total commission) field 632; net value field 634; and amount bought/sold field 636.

It should be noted that while the fields shown in FIG. 6, as well as the other FIGURES, are detailed, nevertheless, these fields are not intended to be exhaustive and other fields are also possible. For example, blotter 600 includes fields that may typically be included on a conventional order blotter. Furthermore, a field that shows the cost of borrow or borrow rate may be included on the borrow blotter. Additionally, a field that “nets out” or subtracts the cost of borrow from the profit and loss may be included as well.

FIG. 7 shows an interactive stock borrow dialogue box according to the invention. Stock borrow dialogue box 700 may display source field 702; shares available field 704; last update field 706; uploaded by broker at/field 708; rate (bps) field 710; dividend rate field 712; call/non call field 714; deliver2PB field 716; comment field 718; borrow quantity field 720 and borrow execute button 722.

Thus, systems and methods for enabling borrowing of stock according to the invention have been provided. Persons skilled in the art will appreciate that the present invention can be practiced by other than the described embodiments, which are presented for purposes of illustration rather than of limitation, and the present invention is limited only by the claims which follow.

What is claimed is:

1. A graphical user interface (GUI) that facilitates borrowing shares of a pre-determined stock, the GUI comprising:
a display of a plurality of lender names;
a display of a number of shares of the pre-determined stock available from each lender; and
a display of a lending rate associated with each of the lender names.

2. An electronic trading system comprising the GUI of claim 1, the GUI further comprising an update field that displays an update to the number of shares available, the update being displayed in response to activity internal to, or external to, the electronic trading system.

3. The GUI of claim 1 further comprising a delivery field, the delivery field that displays a party to whom the shares of stock are transferred from the lender.

4. The GUI of claim 1 further comprising a comment field, the comment field that provides a platform for interactive communication between a borrower and the lender.

5. The GUI of claim 1 that forms part of an electronic trading system, the GUI that further comprises a plurality of selectable lender names, the electronic trading system that displays an interactive stock borrow dialogue box in response to a user selection of one of the plurality of lender names.

6. The electronic trading system of claim 5, the interactive stock borrow dialogue box further comprising an indication of interest field, the indication of interest field that aggregates and segregates a plurality of indications of interest in the stock.

7. The electronic trading system of claim 6, further comprising an interactive stock borrow return dialogue box, the interactive stock borrow return dialogue box that displays an input field that is adapted to receive an amount of shares that a borrower desires to return and that displays a lender field that is adapted to receive an indication of the lender to whom the borrower wishes to return the stock.

8. The GUI of claim 1, further comprising a current borrow position field that displays a participant's current borrow position in the stock.

9. The GUI of claim 1, further comprising a pending borrow position field that displays a participant's submitted but unexecuted borrow position.

10. The GUI of claim 1, further comprising a display of a plurality of lending rates, each displayed lending rate that is for a pre-determined stock and that is associated with one of the lender names.

11. A method of facilitating borrowing shares of a pre-determined stock, the method comprising:
receiving a list of stock lenders, each of the lenders that guarantees the availability of a pre-determined number of shares of the stock;
storing the list of stock lenders and the pre-determined number of shares of the stock guaranteed by each of the lenders;
displaying the list of stock lenders in a Graphical User Interface; and
in response to a selection of one of the stock lenders, displaying an interactive stock borrow dialogue box, the interactive stock borrow dialogue box that displays an input field that is adapted to receive an amount of shares that a borrower desires to borrow.

12. The method of claim 11, further comprising, when the list of stock lenders includes less lenders than a predetermined threshold number, transmitting a request for quote instruction to other lenders in order to determine whether the other lenders agree to guarantee the availability of a pre-determined number of shares of the stock.

13. The method of claim 11, further comprising, when a stock is not guaranteed by one of the stock lenders, then providing an interactive electronic platform for negotiation between the lender and a borrower in order to determine the terms of borrowing the stock.

14. The method of claim 11, further comprising displaying a lending rate associated with at least one of the stock lenders.

15. The method of claim 11, further comprising displaying an amount of stock available from at least one of the stock lenders.

16. The method of claim 15, further comprising updating the amount of stock available from at least one of the stock lenders in response to information relating to the lending of the stock by the at least one of the stock lenders.

17. The method of claim 11, further comprising, in response to a selection of one of the stock lenders, displaying an interactive stock borrow dialogue box, said stock borrow dialogue box that displays an aggregated and segregated indication of interest list.

18. The method of claim 11, further comprising receiving the amount of shares that the borrower desires to borrow and allocating the amount of shares that the borrower desires to borrow to at least one of the lenders, said lender being selected from among the plurality of lenders according to a rule-based hierarchy.

19. The method of claim 18, further comprising providing an interface to a participant to define said rule-based hierarchy.

20. A method of facilitating borrowing shares of a pre-determined stock, the method comprising:
receiving a list of stock lenders, each of the lenders that guarantees the availability of a pre-determined number of shares of the stock;
storing the list of stock lenders and the pre-determined number of shares of the stock guaranteed by each of the lenders;
displaying the list of stock lenders in a selectable Graphical User Interface;
in response to a selection of one of the stock lenders, displaying an interactive stock borrow dialogue box, the interactive stock borrow dialogue box that displays an input field that is adapted to receive an amount of shares that a borrower desires to borrow and that displays a lender field, said lender field that is pre-populated with the user-selected lender; and
in response to a user request to return borrowed stock, displaying an interactive stock borrow return dialogue box, the interactive stock borrow return dialogue box that displays an input field that is adapted to receive an amount of shares that a borrower desires to return and that displays a lender field that is adapted to receive an indication of the lender to whom the borrower wishes to return the stock.
